(19) United States
(12) Patent Application Publication
(10) Pub. No.: US 2025/0211933 A1
(43) Pub. Date: Jun. 26, 2025

(54) GENERATING A NAVIGABLE SOUND FIELD REPRESENTATION

(71) Applicant: Willem Bastiaan Kleijn, Eastborne Wellington (NZ)

(72) Inventor: Willem Bastiaan Kleijn, Eastborne Wellington (NZ)

(21) Appl. No.: 18/999,933

(22) Filed: Dec. 23, 2024

Related U.S. Application Data
(60) Provisional application No. 63/614,791, filed on Dec. 26, 2023.

(51) Int. Cl. H04S 7/00

(52) U.S. Cl. CPC H04S 7/303; H04S 2400/11; H04S 2400/13; H04S 2420/01; H04S 2420/11

(57) ABSTRACT

Disclosed implementations use generative machine learning methods to create sound environments that are consistent with microphone observations or with a recording representation in an existing format, such as ambisonics. Implementations provide a physically plausible sound field rather than an accurate sound field by sampling from the probability distribution of ground truth sound fields.

### CROSS REFERENCE TO RELATED APPLICATION

This application claims the benefit of U.S. Provisional Application No. 63/614,791, filed Dec. 26, 2023, the disclosure of which is incorporated herein by reference in its entirety.

### BACKGROUND

A sound field is formed by a series of compressions and expansions of a substance, which obey the laws of thermodynamics, heat transfer, and fluid mechanics. It is essentially characterized by the pressure, corresponding density, temperature, and particle velocities.

### SUMMARY

Disclosed implementations use generative machine learning methods to create sound environments that are consistent with microphone observations or with a recording representation in an existing format, such as ambisonics. Put another way, the disclosed generative method exploits prior knowledge acquired during training to augment a recording by generating a realistic spatial sound arrangement that is experienced by a listener as a function of location (space) and time. The training includes using a database of transfer function densities from simulated sound fields created with wave-based methods such as the finite-element methods, and/or geometrical-acoustics methods such as the image source method. The disclosed generative method enables a listener to move within a virtual (generated) space, i.e., have six-degrees-of-freedom, with a realistic sound field.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

The following detailed description that sets forth aspects of the subject matter, along with the accompanying drawings of which:

FIG. 1 depicts an example process for generating a representation for a recording from microphones that can be employed by implementations of the present disclosure;

FIG. 2 depicts a process for obtaining transfer function densities for a set of sources in a particular room in the database that can be implemented by implementations of the present disclosure;

FIG. 3 depicts a flowchart of an example sequential generative procedure for the generation of transfer function densities of a set of sources that can be implemented by implementations of the present disclosure;

FIG. 4 depicts a flowchart of an example training procedure from a database of transfer function densities for pairs of sources that can be implemented by implementations of the present disclosure;

FIGS. 5A and 5B each depict an example process for generating signal that satisfies a number of constraints that can be implemented by implementations of the present disclosure;

FIG. 6 depicts an example system that includes a computer or computing device that can be programmed or otherwise configured to implement systems or methods of the present disclosure;

FIG. 7 depicts an example environment that can be employed to execute implementations of the present disclosure; and

FIG. 8 depicts a flowchart of a non-limiting process that can be implemented by implementations of the present disclosure.

### DETAILED DESCRIPTION

The sound field experienced by a listener includes the deviation of air pressure from the ambient pressure, as a function of location and time. In many applications, and in particular applications such as immersive audio reproduction and creation, and augmented or virtual reality, the sound field is represented and processed in both space and time. Whereas the description of continuous temporal signals as a sequence of samples is standard practice, spatial sampling is problematic. Attempts to solve the acquisition problem with laser-based measurements have not led to practical methods. Instead, a range of methods has been developed to acquire, represent, and render the sound field representations. Each method has its advantages and disadvantages in terms of accuracy, brittleness, ease of acquisition, computational cost, and freedom of movement of a listener. Accordingly, the system described herein includes a representation method enabled through models trained through machine learning and provides distinct advantages over existing methods.

A listener generally is surrounded by a “listening region” without sound sources. Sound propagation within such a listening region is described by the wave equation. The sound field in the listening region may be described: 1) directly as a function of time or temporal frequency and space, 2) by characterizing sound waves passing through a virtual surface separating the listening region from the space with sources, or 3) based on knowledge of source locations or directions.

In the temporal frequency domain, the sound field must satisfy the Helmholtz equation. Three approaches have traditionally been used to describe a sound field: Ambisonics, wavefield synthesis, and describing the sound field as a set of plane waves or point sources.

Ambisonics approximates a sound field directly as a finite expansion in spherical harmonics. Such, truncated expansions are accurate within a radius of a predefined origin that decreases with frequency. Ambisonics naturally facilitates spatial rotation of the sound field, but spatial translation of the listener is limited for practicable truncation lengths of the expansion. Numerous methods attempt to interpolate between ambisonics representations with different origins (multipoint recordings). Such methods tend to suffer from comb filtering, spectral coloration, and errors in localization.

Wavefield synthesis is a rendering representation based on the Kirchhoff-Helmholtz equation, which states that the sound field in a source-free region enclosed by a virtual surface can be characterized at that surface alone. A specific sound field representation can be rendered by a continuous source (the aperture) on the surface. For example, this setup is in practice approximated by a set of loudspeakers. Both rotation and translation of the observer are possible in the wavefield synthesis approach. The continuous aperture representation is generally used within the rendering process only. The method does not exploit prior information about typical acoustics behavior and is based on knowledge of the location of a set of primary sources.

A third approach of describing the sound field as a set of plane waves or point sources, each with a particular direction or location. A typical configuration specifies only the direction of a set of plane waves, which means that more than one plane wave may correspond to a single physical source and its reflections. Decorrelation of the plane wave signals can be used to remove the redundancy. The basic representation does not naturally facilitate translation but does facilitate rotation. It is possible to equip the sources with an ambisonics transfer function, which may reduce directional redundancy and facilitate rotation.

Implementations described herein differ from these existing approaches by providing a physically plausible sound field rather than an accurate sound field. In some implementations, the systems and methods described herein sample from the probability distribution of ground truth sound fields, similarly to how image generation methods sample from a distribution of ground truth images. In both cases generative methods, such as neural networks, implicitly learn the distribution from a large number of examples. More precisely, implementations of the systems and methods described herein simultaneously generate transfer functions of a set of sources, subject to known constraints, as an image on an enclosing surface. In some implementations, the generation is based on image processing methods for conventional two-dimensional (2D) image generative modeling. Thus, in some implementations, a sound field description is first decomposed into a set of sources, each consisting of a temporal signal and an image on a 2D closed surface. While the images are temporal frequency dependent, low frequency images (transfer functions) may be smoothed versions of high-temporal frequency images. In some implementations, the employed generative model does not require retraining (zero-shot) to obtain conditioned outcomes for the conditioned training. To train the 2D images on the sphere, in some implementations, data for a large number of spatial scenarios can be generated with wave-based methods such as finite-element or finite difference methods, possibly in combination with geometric acoustics geometric (ray-based) based methods at higher frequencies or with geometric acoustics-based methods alone. These methods facilitate the evaluation of a sound field in a region with arbitrary shape and obstacles.

For convenience, the surface can be an ellipsoid because the relation to a sphere facilitates processing. An ellipsoid also fits within a typical room while facilitating navigation. However, any three-dimensional (3D) shape can be used. The 2D images can be generated with any of the standard neural network-based image generation methods. In some implementations, the images of the sources are dependent, either done simultaneously or sequentially, to ensure that the same room (spatial environment) is represented. In some cases, the generation is constrained on microphone observations or known ambisonics coefficients. In some examples, the spatial information is in the form of sparse microphone observations or in the form of ambisonics coefficients. For example, source locations provided by a sound engineer can be converted to an ambisonics representation.

Accordingly, implementations relate to systems for describing the contribution of each primary source as a continuous secondary monopole source density on a surface enclosing a listener. In an example implementation, the system obtains a flexible spatial sound representation that is based on observations or design parameters and prior knowledge of sound fields. The observations can be microphone signals or ambisonics signals (e.g., ambisonics coefficients in the frequency domain). The parameters may be set by a sound engineer.

In some implementations, the contribution of each primary source is described as a continuous secondary monopole source density on a surface enclosing the listener. The transfer function from a point on the surface to a listener may be described, for example, according to a Green's function. In some examples, the monopole source density on the enclosing surface is the multiplication of a transfer function density (TFD) on the surface and the primary source signal. In some implementations, the TFD does not change with movement of the listener; only the argument of the Green's function changes. In some implementations, when there is no movement of the source and the listener, the overall transfer function from source to listener collapses to a simple transfer function from primary source to listener, reducing computational effort (this can also be exploited for slow movement). The enclosing surface on which the TFD resides is arbitrary, but an ellipsoid is a natural shape, and it is straightforward to change the TED from one surface to another, facilitating listener movement in unexpected directions.

In some implementations, the TFD is generated based on prior knowledge of TFDs but is constrained to sound field observations or the design by a sound engineer. The TFD can be interpreted as a non-Euclidian image that can be discretized spatially, which means it then consists of pixels. The pixels may be arranged in polar coordinates on an ellipsoidal surface. The constraints may result from measurements with omnidirectional or higher-order microphone observations, from an ambisonics description (or recording), or from parameters set by a sound engineer.

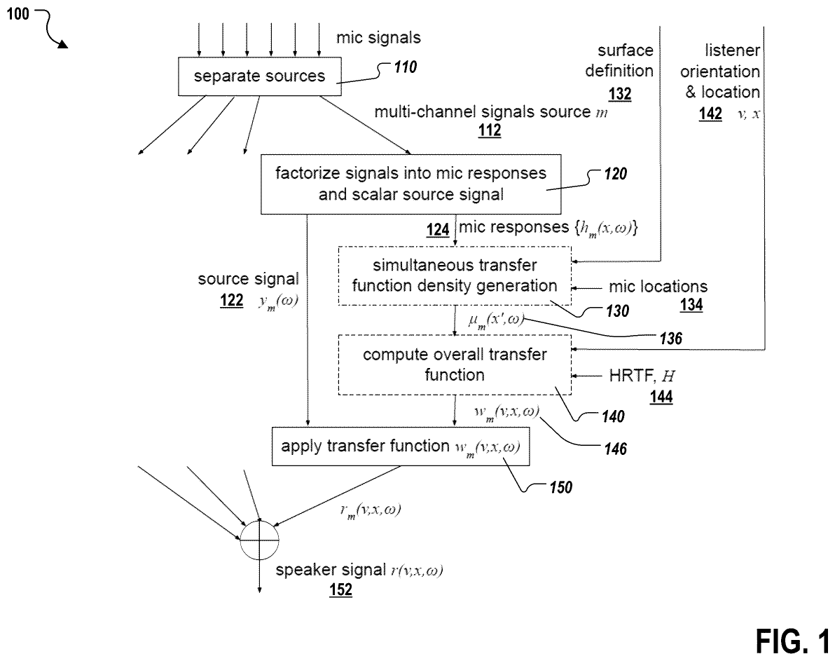

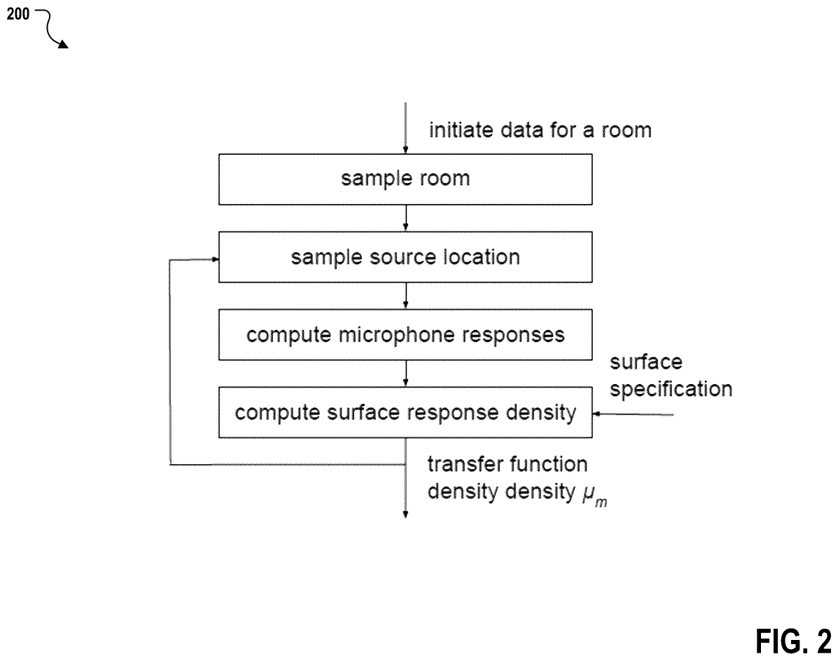

FIG. 1 depicts an example process 100 for generating a representation for a recording from microphones that can be employed by implementations of the present disclosure. As depicted, the sources are first separated (step 110) and the resulting multi-channel signals 112 for each source m are factorized (step 120) into a set of microphone response functions 124 and a scalar source signal 122 with an arbitrary gain and phase. The microphone response functions form the constraint for the generation (step 130) of a TFD 136 generation on the enclosing surface 132. In some implementations, the TFD 136 does not need to be updated if the sources (e.g., microphone locations 134) and the enclosing surface 132 (a surface definition) are static. Put another way, until and unless the source locations, the microphone locations 134 or the enclosing surface 132 changes, the system may use the same generated TFD 136. The TFD 136 generation is trained on a simulation database, as described in more detail with respect to FIG. 2. Once the system has generated the TFD 136 for the enclosing surface 132 and microphone locations 134, the system may compute the overall transfer function 146 for the source (step 140) based on the listener orientation and location 142 and, when the output is provided to a user wearing headphones, a head related transfer function (HRTF) 144. Because the overall transfer function 146 is computed based on listener orientation and the microphone locations 134, the same overall transfer function 146 can be used until the listener changes orientation and the microphone locations 134. This computation can be performed at a rate that is sufficient for tracking listener movement. This rate may be further by interpolating the resultant overall transfer function. The overall transfer function 146 can be applied (step 150) to the scalar source signal 152 to generate an output audio signal (e.g., a speaker signal) for the signal source m, and the results are summed for all sources.

In some implementations, the model employed by the system is trained as it includes a generative component. In some implementations, the system trains the model with information stored to a database of non-Euclidian TFD images (e.g., computed based on sound field simulations). In some implementations, the relations between the sound field and the TED and the TFD and the sources are defined to implement the algorithm and train the generative component.

In some implementations, a transfer function is generated based on the process 100 shown in FIG. 1. That is, for a signal segment covering a finite time interval, a separated single-source multi-channel signal may be factorized into a transfer function for each microphone or ambisonics signal and a single-channel signal in step 120. A neural network implementation in step 130 may then generate at least one complex valued TFD (a complex image) on the surface [symbol] , which may have an ellipsoid shape. The overall transfer function for the separated source to a set of one or more loudspeakers, is then computed in step 140 and applied to that separated source in step 150. The loudspeakers may be located in a headset or may be free-standing loudspeakers.

In some examples, the described system provides a sound field representation described based on virtual sources on enclosing surfaces. In the description that follows, for clarity, frequency ω may be changed to time t in the argument of functions where this is not ambiguous.

For equation (1), x is a spatial location and ω a temporal angular frequency. The sound field is represented as the integral of contributions of a density of monopole density u(x, ω) on a closed virtual surface [symbol] . The representation is then of the form:

$$p ( x , ω ) = {\int }_{𝕊} {dx}^{′} G ( x , {x}^{′} , ω ) u ( x , ω ) , \qquad ( 1 )$$

where G(x, x′, ω) is the Green's function. By design, the path from any point on the surface [symbol] to x is direct and that means the Green's function is of the form:

$$G ( x , {x}^{′} , ω ) = \frac{1}{4 π ‖ x - {x}^{′} ‖} \text{?} , \qquad ( 2 )$$

$$\text{?} \text{indicates text missing or illegible when filed}$$

where c is the speed of sound. With

$$Gx , {x}^{′} , t , {t}^{′} ) = \frac{1}{4 π ‖ x - {x}^{′} ‖} δ ( t - {t}^{′} - \frac{‖ x - {x}^{′} ‖}{c} )$$

the time domain can be defined according to:

$$p ( x , t ) = {\int }_{𝕊} {dx}^{′} \int {dt}^{′} G ( x , {x}^{′} , t , {t}^{′} ) u ( x , {t}^{′} - \frac{‖ x - {x}^{′} ‖}{c} ) . \qquad ( 3 )$$

In examples, equation (3) may be approximated as a summation over a discrete virtual secondary source u. The low-resolution representations of u may lead to undesired interference effects between the discrete secondary sources. In some cases, to obtain an output audio signal (e.g., a headphone speaker signal) r(x, ω) the Green's function is adjusted with the HRTF. The HRTF is denoted as H(v, z, ω), where v is a unit vector denoting the direction of the head and z is a unit vector in the direction of the arriving sound component in the temporal frequency domain. The result is represented according to:

$$r ( υ , x , ω ) = {\int }_{𝕊} {dx}^{′} H ( υ , \frac{x - {x}^{′}}{‖ x - {x}^{′} ‖} , ω ) G ( x , {x}^{′} , ω ) u ( {x}^{′} , ω ) . \qquad ( 4 )$$

Using (3), the time domain can be written according to:

$$r ( υ , x , t ) = {\int }_{𝕊} {dx}^{′} \int {dt}^{′} H ( υ , \frac{x - {x}^{′}}{‖ x - {x}^{′} ‖} , t - {t}^{′} ) p ( {x}^{′} , {t}^{′} ) . \qquad ( 5 )$$

In some cases, the phase shift of the HRTF may be assumed to not affect the interaural time delay in a significant manner. Accordingly, H can be described as a linear-phase filter approximation of the HRTF.

For each primary source, the monopole source density can be written as a multiplication of as a transfer function density vector multiplied by the primary source signal. Assuming a fixed recording representation, the response at the listener for each primary source is a filter that only needs to be updated if the listener or the source moves. In some cases, an update rate of 100 Hz is sufficient for most scenarios.

The monopole density u(x, ω) defined on [symbol] is the sum over such densities for each primary source signal where uₘ(x, ω) is the contribution of primary source m. Then uₘ(x, ω)=uₘ(x, ω) yₘ(ω), where uₘ(x, ω) is an as-yet unknown TFD and yₘ(ω) is the source signal of source m. Thus:

$$u ( x , ω ) = {\sum }_{m ∈ ℳ} {u}_{m} ( x , ω ) = {\sum }_{m ∈ ℳ} {μ}_{m} ( x , ω ) {y}_{m} ( ω ) . \qquad ( 6 )$$

The sound field can then be written as a function of the TFDs according to:

$$p ( x , ω ) = {\int }_{𝕊} {dx}^{′} G ( x , {x}^{′} , ω ) {\sum }_{m ∈ ℳ} {y}_{m} ( ω ) {μ}_{m} ( {x}^{′} , ω ) \qquad ( 7 )$$

$$= {\sum }_{m ∈ ℳ} {y}_{m} ( ω ) {\int }_{𝕊} {dx}^{′} G ( x , {x}^{′} , ω ) {μ}_{m} ( {x}^{′} , ω ) , \qquad ( 8 )$$

where ∫ [symbol] dx′G(x,x′,ω) uₘ(x′, ω) can generally be updated slowly or not at all; it varies only if the listener or the source changes location. In some cases, changing the location x of the user is straightforward as uₘ(x, ω) is unaffected. Assuming suitable interpolation methods for the filter, the required update rate can be bounded by human time resolution of changes of the auditory scene.

The HRTF can be accounted for without requiring significant additional effort. The overall transfer function for source m can be written as wₘ(v, x, ω). Then:

$$r ( υ , x , ω ) = {\sum }_{m ∈ ℳ} {y}_{m} ( ω ) {w}_{m} ( υ , x , ω ) . \qquad ( 9 )$$

$${w}_{m} ( υ , x , ω ) = {\int }_{𝕊} {dx}^{′} H ( υ , \frac{x - {x}^{′}}{‖ x - {x}^{′} ‖} , ω ) G ( x , {x}^{′} , ω ) {μ}_{m} ( {x}^{′} , ω ) . \qquad ( 10 )$$

This can also be written in the time domain as a sum of convolutions of the yₘ(t) and the Fourier transform of wₘ(v, x, ω).

The above section shows that the TFD can be determined when the sound field is known. Accordingly, the described system uses TFDs generated from simulated sound fields (e.g., stored to a database). Functions on the surface [symbol] may be represented by a predefined set of d_{S} sample locations on that surface. As the surface is two-dimensional, these samples may be referred to as pixels, and d_{S} can control the resolution of the functions. In some cases, the pixels cannot be organized in a cartesian grid. However, any grid definition on the surface can be used for this purpose, with different definitions leading to different levels of efficiency. For example, spherical coordinates can be used to define a grid defined by polar angle and azimuth. A modification to improve efficiency may include grouping pixels near azimuth 0 and π together into a single function value.

To find the vector, μₘ(x′, ω), h (x, ω) is used to represent the overall transfer function from source m to a microphone at location x according to:

$$h ( x , ω ) = {\int }_{𝕊} {dx}^{′} G ( x , {x}^{′} , ω ) {μ}_{m} ( {x}^{′} , ω ) . \qquad ( 11 )$$

Furthermore, when μₘ(ω) with μ: [symbol] → [symbol] represents a vector of TFD pixel values and \tilde{G}(x, ω) a vector of pixel values for G(x, x′, ω), then:

$$h ( x , ω ) \approx {\tilde{G} ( x , ω )}^{H} {μ}_{m} ( ω ) , \qquad ( 12 )$$

where H is conjugate a transpose. The function is discretized when hₘ(ω) with hₘ [symbol] ⁺→ [symbol] is a vector of hₘ(x, ω) values for an arbitrary set of x coordinates and G: [symbol] ⁺→ [symbol] is a Green's function matrix, then:

$${h}_{m} ( ω ) = G ( ω ) {μ}_{m} ( ω ) . \qquad ( 13 )$$

It is advantageous to select dₕ<< [symbol] so that the TED is over specified according to:

$${μ}_{m} ( ω ) = {G ( ω )}^{\#} {h}_{m} ( ω ) , \qquad ( 14 )$$

where # is the pseudo-inverse. Hence, by creating a set of simulated sound field scenarios with known hₘ and G, a database of plausible transfer function density vectors μₘ(ω) may be generated.

Sound fields can be simulated with wave-based methods such as finite element and finite difference methods, boundary element methods, and geometrical acoustics-based methods such as the image source method. The former methods generally perform better at low frequencies whereas the latter tend to perform better at higher frequencies. When a multitude of room scenarios are generated, each with a single source, then the sound field within the room can be calculated. More specifically, the sound field response function can be computed and denoted as hₘ(x, ω) for source m. In some implementations, the simulation method leads to a linear response so that the source signals can be added.

Described implementations allow for any number of sources in a single room and this is reflected in the database generation. To create a suitable database, it is important to note that two generative systems can be sufficient: an unconditional transfer function density generative system, and a second transfer function density generative system that is conditional on the first one and uses the same room. In some implementations, a database is used that for each room that has discrete transfer function densities (also referred to herein as secondary sources) μ₁, μ₂ for at least two sources in the room. For a pair of sources, the database can be described according to {μ₁^{k}, μ₂^{k}}k∈K, where K is the set of room labels for the database. FIG. 2 depicts a process 200 for obtaining transfer function densities for a pair of sources in a particular room in the database.

In some implementations, the system employs a database that includes the TFDs μ for each of a set of discrete frequencies @ at a reasonable frequency resolution. For a source with label 0 in room k, the TED in the frequency domain can be defined according to:

$${μ}_{0}^{k} ( ω , x ) = {a}_{0}^{k} ( ω , x ) {e}^{- j ω {τ}_{0}^{k} ( ω )} . \qquad ( 15 )$$

where a₀^{k}: [symbol] and τ₀^{k}: [symbol] represent amplitude and delay, respectively. In a simple setup the delay τ₀^{k} may be constant as a function of frequency. In some implementations, a TFD density database is employed for a single representative frequency, which is also used for the full signal bandwidth. In some examples, a small set of representative frequencies can be used together with a form of interpolation across frequency during inference.

A realistic immersive environment can be generated by the training of a generative system that can generate a physically reasonable set of transfer function densities μₘ at the preset resolution. In the example case with a single source transfer function densities at a single frequency without knowledge about the physical environment (e.g., recording with a single microphone signal and no further conditioning) an image generation problem on the non-Euclidean surface [symbol] is obtained. In such an example, the image μ₀ can have a set number of pixels (spatial resolution), and a number of channels equal to the frequency resolution. In such examples, deep learning training and inference methods can be used. Thus, variational autoencoders, normalizing flows, generative adversarial networks, and diffusion can be used.

In some implementations, multiple sources are associated with the same room (the same procedure may be used for a single source). For cases that include a single complex (magnitude-phase) image for each source, simultaneously 2M-channel images can be trained where M is the number of sources. In such cases, the number of data required scales exponentially with the number of sources M.

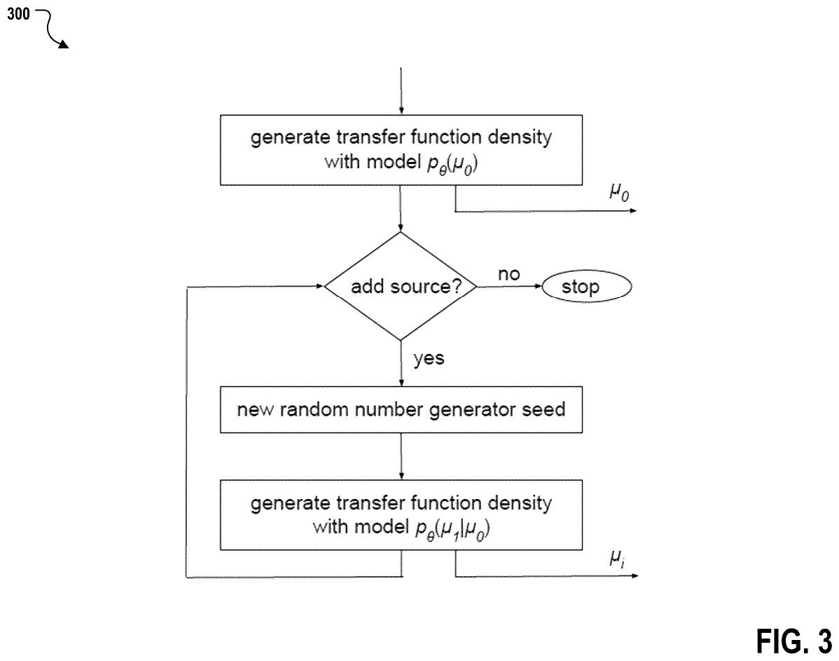

In some implementations, the image of a first source is generated and used as conditioning information for each subsequently generated TFD for other sources in the same room, one at a time. To state another way, the system learns/trains a first generative model p_{θ}_{₀}(μ₀) and then a second generative model p_{θ}_{₁}(μ₁|μ₀) that describes the same room as μ₀. In some implementations, the database requirement of this subsequent-generation method is independent of the number of sources. Moreover, the subsequent-generation method facilitates the introduction of new sources (and the removal of old ones) to an existing sound arrangement. FIG. 3 depicts a flowchart of an example sequential generative process 300 for the generation of transfer function densities of a set of sources.

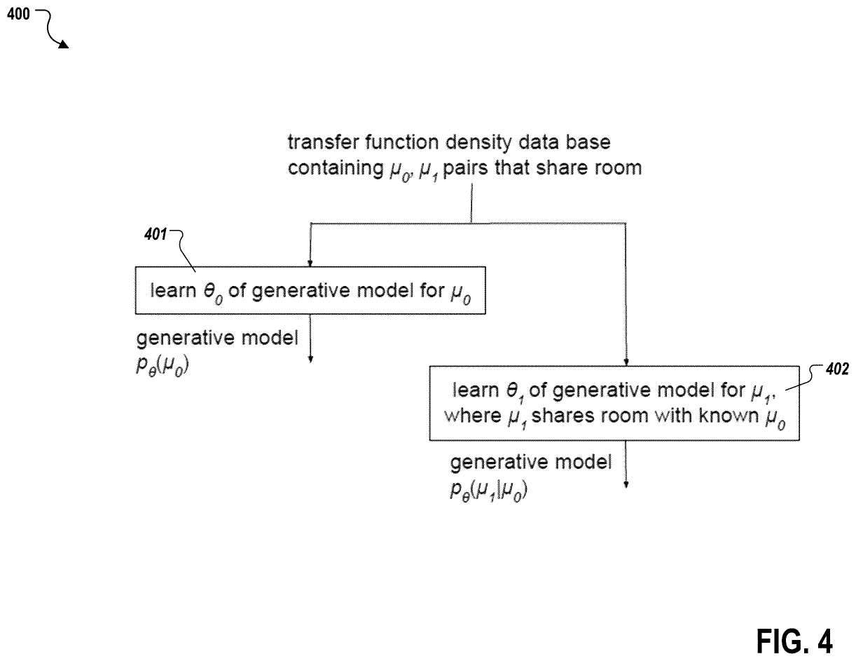

FIG. 4 depicts a flowchart of an example training procedure 400 from a database of transfer function densities for pairs of sources. At 401, the first genitive model p_{θ}_{₀}(μ₀) is trained. At 402, the second generative model p_{θ}_{₁}(μ₁|μ₀) that describes the same room as μ₀ is trained. In some implementations, 402 is repeated for each additional source after the first source. With minor adjustments, the training procedure 400 can also be employed in a scenario where sources move.

An example scenario where d_{S} microphones where dₕ of which are true microphones and d_{S}−dₕ are virtual microphones with unknown signals can be interpreted as a generalized inpainting problem or as a conditioning problem. While the generalized inpainting algorithm of (19) is defined for consistency models, the same principle can also be used for algorithms such as diffusion algorithms or stochastic interpolants (11-13). The microphone response vector containing all true and virtual microphones may be defined as \tilde{h}ₘ∈ [symbol] and a mask Ω∈{0, 1}^{d}^{ₛ}^{×d}^{ₛ} is defined as a diagonal matrix with the value 1 on the dimension that corresponds to the true microphones. The Green's matrix is defined as G∈ [symbol] ^{d}^{ₛ}^{×d}^{ₛ} to map the TED μₘ into \tilde{h}ₘ:

$${\tilde{h}}_{m} = G {μ}_{m} . \qquad ( 16 )$$

In some examples, the virtual microphones are selected to result in an invertible Green's matrix G. A zero-shot image editing algorithm may apply without modification with A G.

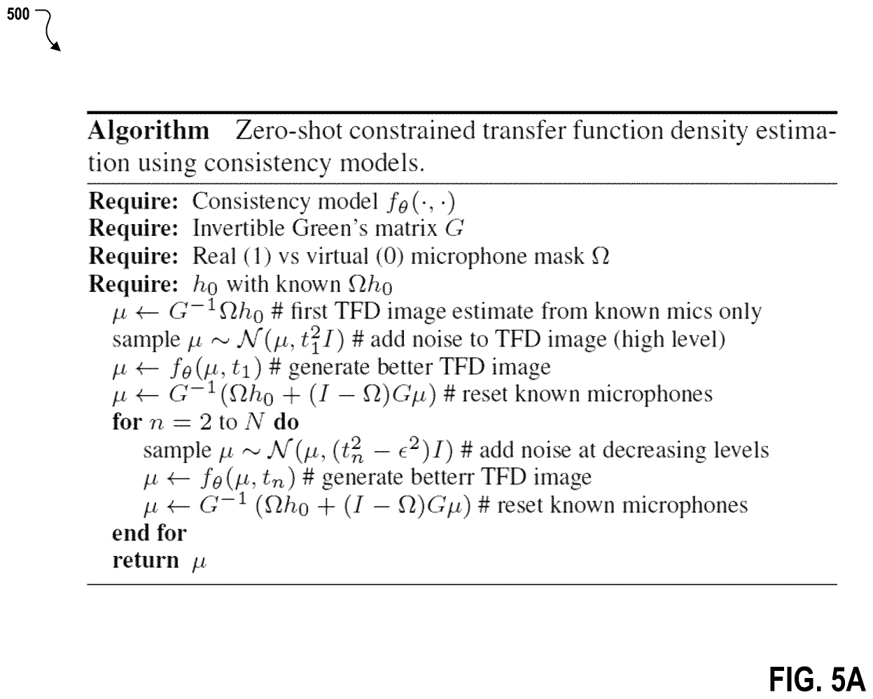

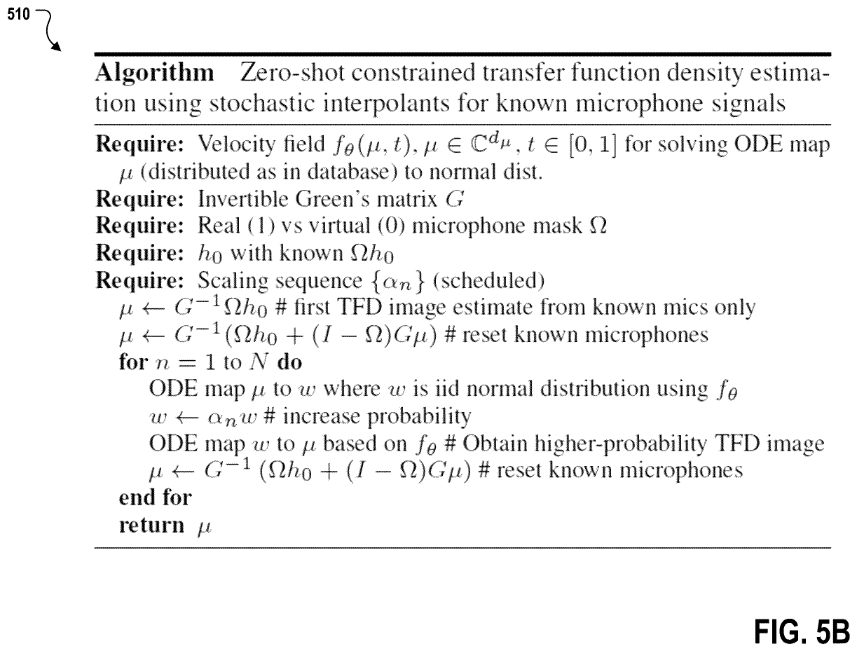

In some implementations, the described system creates a first image that is consistent with the constraint. The vector Ωhₒ includes the true microphone responses with zero virtual microphone responses, which is mapped with G⁻¹ to obtain said first image consistent with the microphone observations. In some implementations, this image is iteratively enhanced based on consistency modeling. Gaussian noise with a particular SNR may be added to the distorted image and generate a new clean signal based on this noisy and distorted image. This “resampled” clean signal is a TFD image u that has improved quality over that of G⁻¹Ωhₒ. The image can be mapped back to the microphone domain to obtain h₁=G_{μ}. The true microphone can be reset to obtain \tilde{h}₁=Ωhₒ+(I−Ω)h₁. The procedure can then be repeated. The iterative procedure is shown in Algorithm 500 depicted in FIG. 5A.

The generalized inpainting algorithm of Algorithm 500 is a particular approach to make a generated signal satisfy the constraints. A second method, Algorithm 510 depicted in FIG. 5B, is based on stochastic interpolants and the notion that distorted signals have low model probability. The stochastic interpolants can be used to find an effective map from the transfer function density image μ to a unit variance independently and identically distributed (iid) normal distribution (Σ>I). In some cases, the map is deterministic.

An alternative approach to satisfying the constraints at least approximately is to view the problem as a conditioning problem where the microphones with known signals form a conventional conditioning on the generative process. In this case, conventional training methods that account for the conditioning can be used. The conventional conditioning method is particularly advantageous for the ambisonics approach discussed below.

Ambisonics is a common representation of local sound fields. Formats used by engineers to specify a spatial sound arrangement can generally be converted into ambisonics format of any desired order in a straightforward manner. Thus, plausible TFDs μₘ(ω) can be generated a surface [symbol] from the ambisonics representations. In the examples below, an ellipsoid surface is referenced; however, as described above, any 3D shape can be used.

In the temporal frequency domain, ambisonics parameterizes the soundfield in terms of a sequence of ambisonics coefficients. Therefore, the soundfield may be specified as a sum of terms each consisting of an ambisonics coefficient multiplying a spherical harmonics basis function. In an example where a soundfield is within a ball centered at the origin, the number of terms (ambisonics coefficients) required for a certain accuracy increases with the ball radius (and with frequency). Accordingly, implementations of the described system employ a generation method for the TFD that 1) matches the soundfield specified by the ambisonics coefficients within that small ball near the origin and 2) complements the ambisonics description to obtain a plausible soundfield outside the small ball. Accordingly, and as outlined below, the vector of known ambisonics coefficients plays precisely the same role as the vector microphone responses for the microphone constraint scenario.

In an illustrative example, where an ambisonics transfer function of order N and where bₙ^{m} is the spherical harmonics coefficients and Yₙ^{m} is the spherical harmonic of degree n and order m, the transfer function is defined according to:

$$h ( r , θ , ϕ , ω ) = {\sum }_{n = 0}^{N} {\sum }_{m = - n}^{m = n} {b}_{n}^{m} ( ω ) {j}_{n} ( rk ) {Y}_{n}^{m} ( θ , ϕ ) \qquad ( 17 )$$

where the polar coordinates are radius r, elevation θ∈[0, π]), and azimuth ϕ∈[0, 2π] and where k=ω/c is the wave number, N is the ambisonics order, and jₙ is the spherical Bessel function. The ambisonics coefficients Bₙ^{m} are related to the spherical harmonics coefficients as bₙ^{m}=iⁿBₙ^{m}. For simplicity, in the following, this concept will often refer to bₙ^{m} as the ambisonics coefficients.

Multiplying the transfer function (17) with a source signal provides the sound field contribution of that source at a location (r, θ, ϕ, ω) with an accuracy that decreases with increasing r and ω and increases with increasing N. Note that for each term in the summation of (17) the angular and radial dependencies factorize, which may be exploiting when determining the parameterization used for the surface. Accordingly, the illustrative ellipsoidal surface [symbol] is defined according to:

$$\frac{{x}_{1}^{2}}{{a}^{2}} + \frac{{x}_{2}^{2}}{{b}^{2}} + \frac{{x}_{1}^{2}}{{c}^{2}} = 1 \qquad ( 18 )$$

where a is the dimension along the polar axis and b and c characterize the equatorial plane. Note that following two standard notations, b is used as a symbol for the second equatorial amplitude and bₙ^{m} is used for ambisonics coefficients notation.

Different parameterizations exist for ellipsoids. Most common is the eccentric anomaly parameterization. However, when working with ambisonics, these angles may not directly specify the location of a point on the ellipsoid. Accordingly, the dependencies on the distance origin to surface and angles may not factorize. Hence, points on the ellipsoid may be parameterized with a straight cartesian description according to:

$${x}_{1} = r cos θ \qquad ( 19 )$$

$${x}_{2} = r sin θ cos ∅ \qquad ( 20 )$$

$${x}_{2} = r sin θ cos ∅ \qquad ( 21 )$$

$$r = \frac{a b c}{\sqrt{{b}^{2} {c}^{2} {cos}^{2} θ + {c}^{2} {a}^{2} {sin}^{2} θ co {s}^{2} ∅ + {a}^{2} {b}^{2} {sin}^{2} θ {sin}^{2} ∅}} \qquad ( 22 )$$

where r is the distance origin to the ellipsoid surface and θ and Ø are elevation and azimuth (equatorial angle) respectively, which is consistent with the ambisonics notation used herein.

With the parameterization of the ellipsoid, an integral of a field ζ(Ø, θ, r) over the surface of the ellipsoid can be computed according to:

$$η = {\int }_{0}^{2 π} d ϕ {\int }_{0}^{π} d θ ζ ( ϕ , θ , r ) s ( θ , ϕ ) sin θ \qquad ( 23 )$$

where r is specified according to (22) and where

$$s ( θ , ϕ , a , b , c ) = \frac{\sqrt{{b}^{4} {c}^{4} {cos}^{2} θ + {c}^{4} {a}^{4} {sin}^{2} θ {cos}^{2} ∅ + {a}^{4} {b}^{4} θ {sin}^{2} ∅}}{{( {b}^{2} {c}^{2} {cos}^{2} θ + {c}^{2} {a}^{2} {sin}^{2} θ {cos}^{2} ∅ + {a}^{2} {b}^{2} {sin}^{2} θ {sin}^{2} ∅ )}^{2}} \qquad ( 24 )$$

responds to the surface expansion/compression of an ellipsoid compared to a unit sphere at the same angle. In the following, the (a, b, c) dependency is omitted from s when that is not ambiguous. The renormalization factor s(θ, Ø) reduces to 1 for a sphere with a=b=c=1.

In some implementation, with the above parameterization of the ellipsoid and ambisonics transfer function of (17), the TFD is parameterized on the ellipsoid using coefficients yₙ^{m} in terms of a renormalized spherical harmonics expansion according to:

$$μ ( θ , ϕ , ω ) = {\sum }_{n = 0}^{∞} {\sum }_{m = - n}^{m = n} {γ}_{n}^{m} ( k ) \frac{1}{jk s ( θ , ϕ ) {h}^{( 1 )} ( k r )} {Y}_{n}^{m} ( θ , ϕ ) \qquad ( 25 )$$

where r is specified by (22) and the hₙ⁽¹⁾ are spherical Hankel functions of the first kind.

The transfer function G(x, x′, k) from a source at x to a microphone at x′ where x′ is a point on the ellipsoid (18) and x is some point within the ellipsoid. Can be described according to:

$$\begin{matrix}G ( x , {x}^{′} , k ) = \frac{{e}^{jk ‖ x - {x}^{′} ‖}}{4 π ‖ x - {x}^{′} ‖} \\ = {\sum }_{n = 0}^{∞} {\sum }_{m = - n}^{n} jk g ( kr - {kr}^{′} ) {Y}_{n}^{m *} ( {θ}^{′} , {ϕ}^{′} ) {Y}_{n}^{m} ( θ , ϕ )\end{matrix} \qquad ( 26 )$$

$$g ( kr - {kr}^{′} ) = {h}_{n}^{( 1 )} ( k max ( {r}^{′} , r ) ) {j}_{n} ( k min ( {r}^{′} , r ) ) \qquad ( 27 )$$

where min(r, r′) is the smaller of r and r′ and where * indicates complex conjugate. Note that the terms of (26) factorize in radial and angular components. In some cases, r<r′, [symbol] is selected as g(kr, kr′)=hₙ⁽¹⁾(kr′)jₙ(kr) without loss of generality as it implies that the matching of the soundfield generated by the TED to the soundfield corresponding to the ambisonics representation is constrained to within a ball inscribed inside the ellipsoid.

In some cases, the soundfield specified by the ambisonics coefficients near the origin are known and the response resulting from the TFD, within the inscribed ball r<r′, [symbol] can be defined according to:

$$\begin{matrix}h ( r , θ , ϕ , ω ) = {\int }_{0}^{π} d {θ}^{′} {\int }_{0}^{2 π} d {ϕ}^{′} μ ( {θ}^{′} , {ϕ}^{′} , ω ) G ( x , {x}^{′} ) s ( {θ}^{′} , {ϕ}^{′} ) sin {θ}^{′} & ( 28 ) \\ = {\sum }_{n = 0}^{∞} {\sum }_{m = - n}^{n} jk {γ}_{n}^{k} ( ω ) {j}_{n} ( kr ) {Y}_{n}^{m} ( θ , ϕ ) & ( 29 )\end{matrix}$$

where (25) and orthonormality of the spherical harmonics over the unit sphere are used.

In some cases, the transfer function of (17) and the result from (25) are set to be equal at locations near the origin (small r) as it is where the ambisonics representation is valid. To that purpose, mode matching may be performed where the coefficients of the orthogonal basis functions are matched to obtain:

$${y}_{n}^{m} ( ω ) = {b}_{n}^{m} ( ω ) . \qquad ( 30 )$$

Thus, the TED expansion coefficients yₙ^{m}(ω) of (25) equal the ambisonics coefficients bₙ^{m}(ω). When yₙ^{m}=n>N, then the mode matching results in the matching of the soundfield created by the TFD to the soundfield corresponding to the ambisonics description of order N.

In some cases, mode matching may be sufficient for certain situations but does not exploit the ability to generate plausible TFDs subject to constraints. In some cases, finite-order ambisonics specifies soundfields that are spatially smooth.

For the generation of a soundfield conditional on an order N ambisonics soundfield at the origin, yₙ^{m}(ω) for 0≤n≤N and −n≤m≤n are known from (30). In some implementations, orthogonality of the spherical harmonics then provides constraint equations for μ(ω) according to:

$${γ}_{n}^{m} ( ω ) = {\int }_{0}^{π} d θ {\int }_{0}^{2 π} d ϕ μ ( θ , ϕ ) s ( θ , ϕ ) {h}_{n}^{( 1 )} ( kr ) {Y}_{n}^{m} ( θ , ϕ ) sin ( θ ) \\ n = 0 , … , N , - n \leq m \leq n \qquad ( 31 )$$

where r is specified by (22).

In a practical setup with discrete pixels (31), with (30), reduces to a matrix equation of the form:

$$β = Y μ , β ∈ {ℂ}^{{( N + 1 )}^{2}} \qquad ( 32 )$$

where β is a complex vector of dimensionality (N+1)² of known ambisonics coefficients (N is the ambisonics order) and u is a complex vector that has a dimensionality equal to the known ambisonics coefficients. This is similar in form to (16) and the same method for constrained generation can be used. Alternatively, the known ambisonics coefficients can be seen as a conditioning for the generated soundfield. In practical scenarios, the known ambisonics coefficients are generally a set of low-order (e.g., first-order) ambisonics coefficients. In contrast to the problem with known microphone signals (where the microphone location typically will vary), the set of known ambisonics coefficients is commonly the same for a large group of applications. This property makes a conventional conditioning approach effective for the ambisonics problem.

Accordingly, the vector of known ambisonics coefficients, in some implementations, plays the same role as the vector microphone responses for the microphone constraint scenario. Thus, either algorithm can be used to determine a plausible soundfield also for the ambisonics constraint.

In some examples, the specific location of primary sources is not required for the setup of the system, other than that these sources should be outside the closed surface S. When the location of a particular primary source is inside [symbol] at a known location, the internal source can be transformed into an external source by enveloping internal source with a second closed surface that formally is part of [symbol] by connecting it with a tube of vanishingly small diameter.

In some examples, the second surface is advantageously chosen to be a sphere of small diameter. The transfer function density contribution on that second surface vanishes for all sources except for the source the second surface envelopes. The transfer function density of the enveloped source on the sphere can be computed analytically using the Green's function. However, in many cases, this step is unnecessary as the direct-path contribution of the primary source at its known internal location can be added as a separate source to the listener. Upon subtracting the effect of the direct path contribution for this source for each real or virtual microphone, the transfer function density for the enclosed source on the original surface [symbol] (without the sphere enclosing the internal source) can be computed. This TFD corresponds to the reverberation component of the enclosed primary source.

For a new scenario, a surface So may be modified to a surface [symbol] ₁ for a new scenario. For example, a listener may move in an unanticipated direction. In such a scenario, the resolution dₛ_{₁}= [symbol] is identical for all surfaces may be assumed to simplify the problem. For each source, the sound field response hₘ at a diverse set of [symbol] real and virtual microphones for a given first surface [symbol] ₀ can be computed. The virtual microphone locations can be selected opportunistically. The transfer function density can then be computed at a second surface that encloses the real and virtual microphones using μₘ^{(l)}=Gₗ⁻¹hₘ, where G₁ is the Green's function matrix for the surface [symbol] ₁.

In some examples, the source can be separated into |M|−1 signals and a remainder component. In some cases, the separation operation does not need to perform good separation to obtain good rendering performance, but minimal nonlinear distortion should result. In some cases, any leakage of a particular source signal into other signals will result in an imperfect spatial image of that source. However, when the properly separated component dominates for each particular source, the spatial image will resemble the plausible image that was intended.

While advanced machine learning based separation methods (for example the methods based on TasNet) can be used if they do not result in significant temporal signal distortion, relatively straightforward separation methods that use a separation matrix for the input signals (such as independent vector analysis or methods based on nonnegative matrix factorization can also be used. The output signal can be selected to be the signal amplitude and phase as observed at a particular (usually a centrally located microphone).

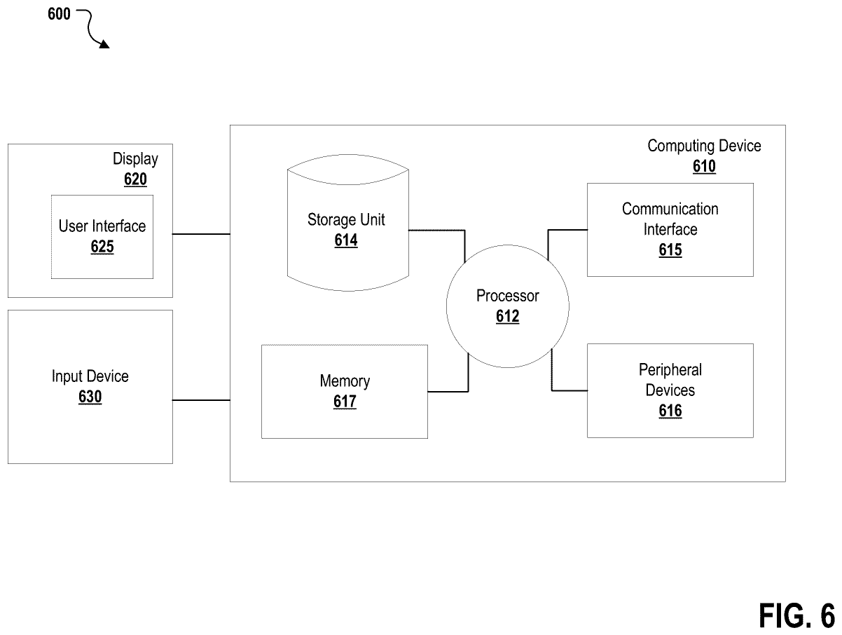

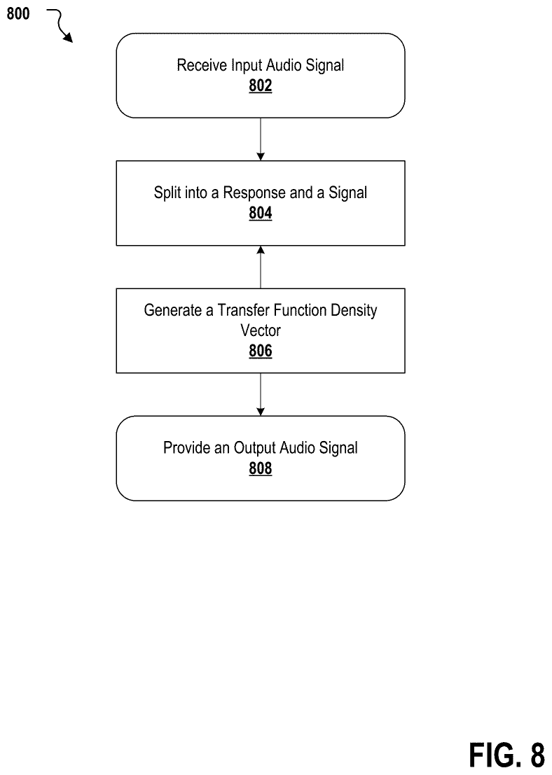

FIG. 6 depicts an example computing system 600 that includes a computer or computing device 610 that can be programmed or otherwise configured to implement systems or methods of the present disclosure. For example, the computing device 610 can be programmed or otherwise configured to implement the process 800 described below with reference to FIG. 8.

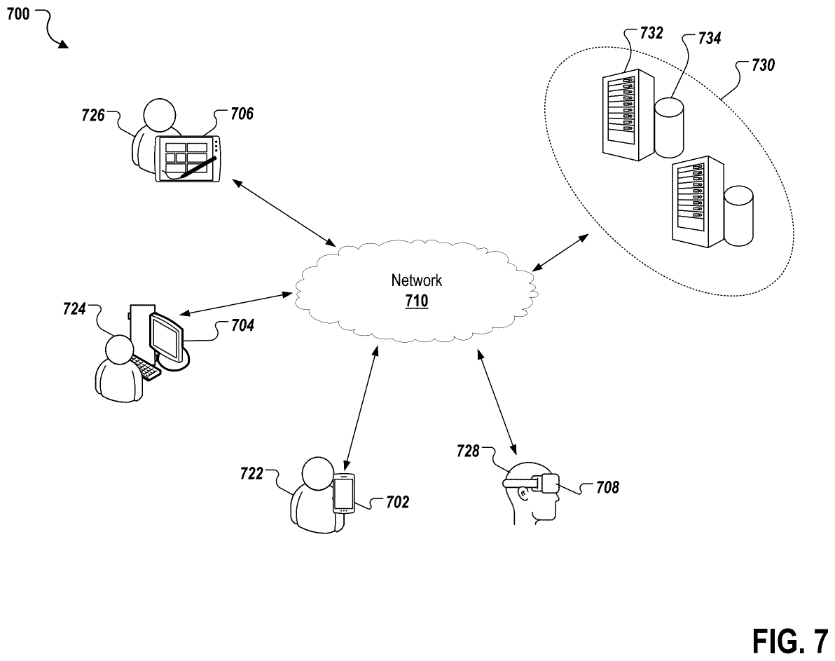

In the depicted embodiment, the computer or computing device 610 includes an electronic processor (also “processor” and “computer processor” herein) 612, such as a central processing unit (CPU) or a graphics processing unit (GPU), which is optionally a single core, a multi core processor, or a plurality of processors for parallel processing. The depicted embodiment also includes memory 617 (e.g., random-access memory, read-only memory, flash memory), electronic storage unit 614 (e.g., hard disk or flash), communication interface module 615 (e.g., a network adapter or modem) for communicating with one or more other systems, and peripheral devices 616, such as cache, other memory, data storage, microphones, speakers, and the like. In some implementations, the memory 617, storage unit 614, communication interface module 615 and peripheral devices 616 are in communication with the electronic processor 612 through a communication bus (shown as solid lines), such as a motherboard. In some implementations, the bus of the computing device 610 includes multiple buses. The above-described hardware components of the computing device 610 can be used to facilitate, for example, an operating system and operations of one or more applications (e.g., a browser application) executed via the operating system. For example, a browser application may be provided via the user interface 625 and configured to manage resource content, such as webpage content, provided by a resource provider (e.g., an application server executed by the back-end system 730 described below with reference to FIG. 7). In some implementations, the computing device 610 includes more or fewer components than those illustrated in FIG. 6 and performs functions other than those described herein.

In some implementations, the memory 617 and storage unit 614 include one or more physical apparatuses used to store data or programs on a temporary or permanent basis. In some implementations, the memory 617 is volatile memory and requires power to maintain stored information. In some implementations, the storage unit 614 is non-volatile memory and retains stored information when the computer is not powered. In further implementations, memory 617 or storage unit 614 is a combination of devices such as those disclosed herein. In some implementations, memory 617 or storage unit 614 is distributed across multiple machines such as a network-based memory or memory in multiple machines performing the operations of the computing device 610.

In some cases, the storage unit 614 is a data storage unit or data store for storing data. In some instances, the storage unit 614 stores files, such as drivers, libraries, and saved programs. In some implementations, the storage unit 614 stores data received by the device (e.g., audio data). In some implementations, the computing device 610 includes one or more additional data storage units that are external, such as located on a remote server that is in communication through a network (e.g., communications network 710 described below with reference to FIG. 7).

In some implementations, platforms, systems, media, and methods as described herein are implemented by way of machine or computer executable code stored on an electronic storage location (e.g., non-transitory computer readable storage media) of the computing device 610, such as, for example, on the memory 617 or the storage unit 614. In further implementations, a computer readable storage medium is optionally removable from a computer. Non-limiting examples of a computer readable storage medium include compact disc read-only memories (CD-ROMs), digital versatile discs (DVDs), flash memory devices, solid state memory, magnetic disk drives, magnetic tape drives, optical disk drives, cloud computing systems and services, and the like. In some cases, the computer executable code is permanently, substantially permanently, semi-permanently, or non-transitorily encoded on the media.

In some implementations, the electronic processor 612 is configured to execute the code. In some implementations, the machine executable or machine-readable code is provided in the form of software. In some examples, during use, the code is executed by the electronic processor 612. In some cases, the code is retrieved from the storage unit 614 and stored on the memory 617 for ready access by the electronic processor 612. In some situations, the storage unit 614 is precluded, and machine-executable instructions are stored on the memory 617.

Examples of operations performed by the electronic processor 612 can include fetch, decode, execute, and write back. In some cases, the electronic processor 612 is a component of a circuit, such as an integrated circuit. One or more other components of the computing device 610 can be optionally included in the circuit. In some cases, the circuit is an application specific integrated circuit (ASIC) or a field programmable gate arrays (FPGAs). In some cases, the operations of the electronic processor 612 can be distributed across multiple machines (where individual machines can have one or more processors) that can be coupled directly or across a network.

In some cases, the computing device 610 is optionally operatively coupled to a communication network, such as the communications network 710 described below with reference to FIG. 7, via the communication interface module 615, which may include digital signal processing circuitry where necessary. Communication interface module 615 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a transceiver. In addition, short-range communication may occur, such as using a BLUETOOTH™, WI-FI, or other such transceiver. In addition, the computing system 600 may include a Global Positioning System (GPS) receiver module that may provide additional navigation- and location-related wireless data to the computing device 610. In some cases, the computing device 610 communicates with one or more remote computer systems through the communication network. In some cases, a user can access the computing device 610 via the network. In some cases, the computing device 610 is configured as a node within a peer-to-peer network.

In some cases, the computing device 610 includes or is in communication with one or more output devices 620. In some cases, the output device 620 includes a display to send visual or audio information to a user. In some cases, the output device 620 is a touch sensitive display that combines a display with a touch sensitive element that is operable to sense touch inputs as and functions as both the output device 620 and the input device 630. For example, the output device 620 may include a Thin-Film-Transistor Liquid Crystal Display (TFT LCD) or an Organic Light Emitting Diode (OLED) display, or other appropriate display technology. In still further cases, the output device 620 is a combination of devices such as those disclosed herein. In some cases, the output device 620 displays a user interface 625 generated by the computing device (for example, a browser application executed by the computing device 610).

In some cases, the computing device 610 includes or is in communication with one or more input devices 630 that are configured to receive information from a user. In some cases, the input device 630 is a keyboard. In some cases, the input device 630 is a keypad (e.g., a telephone-based keypad). In some cases, the input device 630 is a cursor-control device including, by way of non-limiting examples, a mouse, trackball, trackpad, joystick, game controller, or stylus. In some cases, as described above, the input device 630 is a touchscreen or a multi-touchscreen. In other cases, the input device 630 is a microphone to capture voice or other sound input. In other cases, the input device 630 is a camera or video camera. In still further cases, the input device is a combination of devices such as those disclosed herein.

In some cases, the computing device 610 includes an operating system configured to perform executable instructions. The operating system is, for example, software, including programs and data that manages the device's hardware and provides services for execution of applications.

It should also be noted that a plurality of hardware and software-based devices, as well as a plurality of different structural components may be used to implement the described examples. In addition, implementations may include hardware, software, and electronic components or modules that, for purposes of discussion, may be illustrated and described as if most of the components were implemented solely in hardware. In some implementations, the electronic-based aspects of the disclosure may be implemented in software (e.g., stored on non-transitory computer-readable medium) executable by one or more processors, such as electronic processor 612. As such, it should be noted that a plurality of hardware and software-based devices, as well as a plurality of different structural components may be employed to implement various implementations. It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

FIG. 7 depicts an example environment 700 that can be employed to execute implementations of the present disclosure. The example environment 700 includes computing devices 702, 704, 706, 708; a back-end system 730, and a communications network 710. The communications network 710 may include wireless and wired portions. In some cases, the communications network 710 is implemented using one or more existing networks, for example, a cellular network, the Internet, a land mobile radio (LMR) network, a Bluetooth network, a wireless local area network (for example, Wi-Fi), a wireless accessory Personal Area Network (PAN), a Machine-to-machine (M2M) network, and a public switched telephone network. The communications network 710 may also include future developed networks. In some implementations, the communications network 710 includes the Internet, an intranet, an extranet, or an intranet and/or extranet that is in communication with the Internet. In some implementations, the communications network 710 includes a telecommunication or a data network.

In some implementations, the communications network 710 connects web sites, devices (e.g., the computing devices 702, 704, 706, 708) and back-end systems (e.g., the back-end system 730). In some implementations, the communications network 710 can be accessed over a wired or a wireless communications link. For example, mobile computing devices (e.g., the smartphone device 702 and the tablet device 706), can use a cellular network to access the communications network 710.

In some examples, the users 722, 724, 726, and 728 interact with the system through a graphical user interface (GUI) (e.g., the user interface 625) or application (e.g., a browser application) that is installed and executing on their respective computing devices 702, 704, 706, or 708. In some examples, the computing devices 702, 704, 706, and 708 provide viewing data to screens with which the users 722, 724, 726, and 728, can interact. In some examples, the computing devices 702, 704, and 706 provide audio data (e.g., via a headset or an earpiece) determined according to the sound field received from the back-end system and determined according to implementation of the described system. In some implementations, the computing devices 702, 704, 706 and 708 are sustainably similar to computing device 610 described above with reference to FIG. 6. The computing devices 702, 704, 706 and 708 may each include any appropriate type of computing device, such as a desktop computer, a laptop computer, a handheld computer, a tablet computer, a personal digital assistant (PDA), an augmented reality (AR)/virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

Four user computing devices 702, 704, 706 and 708 are depicted in FIG. 7 for simplicity. In the depicted example environment 700, the computing device 702 is depicted as a smartphone, the computing device 704 is depicted as a tablet-computing device, the computing device 706 is depicted as a desktop computing device, and the computing device 708 is depicted as an AR/VR device. It is contemplated, however, that implementations of the present disclosure can be realized with any of the appropriate computing devices, such as those mentioned previously. Moreover, implementations of the present disclosure can employ any number of devices as required.

In some implementations, the back-end system 730 includes at least one server device 732 and optionally, at least one data store 734. In some implementations, the server device 732 is sustainably similar to computing device 610 depicted in FIG. 6. In some implementations, the server device 732 is a server-class hardware type device. In some implementations, the back-end system 730 includes computer systems using clustered computers and components to function as a single pool of seamless resources when accessed through the communications network 710. For example, such implementations may be used in data center, cloud computing, storage area network (SAN), and network attached storage (NAS) applications. In some implementations, the back-end system 730 is deployed using a virtual machine(s).

In some implementations, the data store 734 is a repository for persistently storing and managing collections of data. Example data stores that may be employed within the described system include data repositories, such as a database as well as simpler store types, such as files, emails, and so forth. In some implementations, the data store 734 includes a database. In some implementations, a database is a series of bytes or an organized collection of data that is managed by a database management system (DBMS).

In some implementations, the back-end system 730 hosts one or more computer-implemented services provided by the described system with which users 722, 724, 726, and 728 can interact using the respective computing devices 702, 704, 706, and 708. For example, in some implementations, the back-end system 730 is configured to provide sound fields or audio data determined using the above-described sound field.

FIG. 8 depicts a flowchart of an example process 800 that can be implemented by implementations of the present disclosure. The example process 800 generally shows in more detail how an output audio signal can be generated from an input audio signal that includes a representation of audio originating from a source within an environment. The process 800 may be run in parallel for multiple source signals, and the resulting output signals may be added.

For clarity of presentation, the description that follows generally describes the example process 800 in the context of FIGS. 1-7. For example, the example process 800 can be implemented by systems and components described above with reference to FIGS. 6 and 7. However, it will be understood that the process 800 may be performed, for example, by any other suitable system, environment, software, and hardware, or a combination of systems, environments, software, and hardware as appropriate. In some implementations, various operations of the process 800 can be run in parallel, in combination, in loops, or in any order.

At 802, an input audio signal that includes a representation of audio originating from a source within an environment is received. In some implementations, the input audio signal includes one or more channels having recordings by one or more recording devices. In some implementations, generating the transfer function density vector is based on a location of the one or more recording devices. In some implementations, the one or more recording devices include one or more microphones. In some implementations, the input audio signal includes one or more channels of an ambisonics spatial audio representation.

From 802, the process 800 proceeds to 804 where the input audio signal is split into a response function or factor and a scalar source signal. In some implementations, the input audio signal and the environment are generated by a generative model. In some implementations, the generative model is trained based on a plurality of sound field simulations. In some implementations, the environment is a virtual room having virtual obstacles.

From 804, the process 800 proceeds to 806 where a transfer function density vector for a set of points located on a surface of a virtual three-dimensional shape projected into the environment is generated based on the response function or factor. In some implementations, generating the transfer function density vector is based on knowledge learned from training on a set of ground truth data or approximations thereof. In some implementations, the virtual three-dimensional shape separates a Euclidean space into two, fully connected parts. In some implementations, the virtual three-dimensional shape does not enclose a finite spatial region. In some implementations, the virtual three-dimensional shape and the transfer function density vector are a representation of the audio generated by the source within the environment. In some implementations, the virtual three-dimensional shape has no internal sound sources. In some implementations, the source is external to the virtual three-dimensional shape. In some implementations, the virtual three-dimensional shape is a convex shape. In some implementations, the virtual three-dimensional shape is an ellipsoid.

From 806, the process 800 proceeds to 808 where an output audio signal that is generated based on the scalar source signal and the transfer function density vector is provided. In some implementations, generating the output audio signal includes generating an overall transfer function based on the transfer function density vector and a distance from the set of points located on the surface of the virtual three-dimensional shape from an audio output device located inside the virtual three-dimensional shape; and applying the overall transfer function to the scalar source signal. In some implementations, the overall transfer function is generated based on a head related transfer function, the transfer function density vector, and the distance from the set of points located on the surface of the virtual three-dimensional shape from the audio output device located inside the virtual three-dimensional shape. In some implementations, applying the overall transfer function to the scalar source signal corresponds to multiplying the scalar source signal by a complex gain at a location on the surface of the virtual three-dimensional shape of the set of points. In some implementations, the complex gain at the locations on the surface of the virtual three-dimensional shape is represented by an image. In some implementations, the audio output device includes a loudspeaker in a free-standing arrangement, in an integrated device such as a soundbar, or in headphones. In some implementations, generating the output audio signal includes recalculating the overall transfer function as the audio output device moves through the virtual three-dimensional shape; and reapplying the recalculated overall transfer function to the scalar source signal. In some implementations, providing the output audio signal includes providing the output audio signal to a virtual output audio device located inside of the virtual three-dimensional shape. From 808, the process 800 ends or repeats.

In some implementations, the TFD generation is shown step 130 of process 100 (see FIG. 1) is performed as shown in FIG. 8 according to process 800. In some implementations, for a first source, the TFD generation process is executed without conditioning on another TFD. For two or more sources, in some implementations, the TFD generation for the second and any subsequent sources may be subject to a previously generated TFD, generally the TFD of the first source.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The functionality of computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Unless otherwise defined, all technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method executed by an electronic processor and comprising:
receiving an input audio signal comprising a representation of audio originating from a source within an environment;
splitting the input audio signal into a response function and a scalar source signal;
generating, based on the response function, a transfer function density vector for a set of points located on a surface of a virtual three-dimensional shape projected into the environment; and
providing an output audio signal generated based on the scalar source signal and the transfer function density vector.

2. The method of claim 1, wherein receiving the input audio signal includes receiving one or more channels comprising recordings by one or more recording devices or an ambisonics spatial audio representation.

3. The method of claim 2, wherein generating the transfer function density vector is based on a location of the one or more recording devices.

4. The method of claim 1, wherein generating the output audio signal includes:
generating an overall transfer function based on the transfer function density vector and a distance from the set of points located on the surface of the virtual three-dimensional shape from an audio output device located inside the virtual three-dimensional shape; and
applying the overall transfer function to the scalar source signal.

5. The method of claim 4, wherein the overall transfer function is generated based on a head related transfer function, the transfer function density vector, and the distance from the set of points located on the surface of the virtual three-dimensional shape from the audio output device located inside the virtual three-dimensional shape.

6. The method of claim 4, wherein applying the overall transfer function to the scalar source signal corresponds to multiplying the scalar source signal by a complex gain at a location on the surface of the virtual three-dimensional shape of the set of points.

7. The method of claim 6, wherein the complex gain at the location on the surface of the virtual three-dimensional shape is represented by an image.

8. The method of claim 4, wherein generating the output audio signal includes:
recalculating the overall transfer function as the audio output device moves through the virtual three-dimensional shape; and
reapplying the recalculated overall transfer function to the scalar source signal.

9. The method of claim 1, wherein providing the output audio signal includes providing the output audio signal to a virtual output audio device located inside of the virtual three-dimensional shape.

10. The method of claim 1, wherein the virtual three-dimensional shape separates a Euclidean space into two, fully connected parts.

11. The method of claim 1, wherein the representation of the audio included in the input audio signal is a first representation and the transfer function density vector includes a second representation of the audio.

12. The method of claim 1, further comprising generating the input audio signal and the environment using a generative model.

13. The method of claim 12, wherein the generative model is trained based on a plurality of sound field simulations.

14. A system comprising:
an output audio device; and
an electronic processor communicably coupled to the output audio device and configured to:
receive an input audio signal comprising a representation of audio originating from a source within an environment;
split the input audio signal into a response function and a scalar source signal;
generate, based on the response function, a transfer function density vector for a set of points located on a surface of a virtual three-dimensional shape projected into the environment; and
provide, to the output audio device, an output audio signal generated based on the scalar source signal and the transfer function density vector.

15. The system of claim 14, further comprising:
a recording device communicably coupled to the electronic processor,
wherein the electronic processor is further configured to receive the input audio signal includes receiving one or more channels comprising recordings by the recording device.

16. The system of claim 15, wherein the electronic processor is further configured to generate the transfer function density vector based on a location of the recording device.

17. The system of claim 14, wherein the output audio device is a virtual audio device located inside of the virtual three-dimensional shape.

18. A non-transitory computer-readable medium storing executable instructions that when executed an electronic processor, cause the electronic processor to:
receive an input audio signal comprising a representation of audio originating from a source within an environment;
split the input audio signal into a response function and a scalar source signal;
generate, based on the response function, a transfer function density vector for a set of points located on a surface of a virtual three-dimensional shape projected into the environment; and
provide an output audio signal generated based on the scalar source signal and the transfer function density vector.

19. The non-transitory computer-readable medium of claim 18, wherein the executable instructions further cause the electronic processor to generate the output audio signal by:
generating an overall transfer function based on the transfer function density vector and a distance from the set of points located on the surface of the virtual three-dimensional shape from an audio output device located inside the virtual three-dimensional shape; and
applying the overall transfer function to the scalar source signal.

20. The non-transitory computer-readable medium of claim 19, wherein the overall transfer function is generated based on a head related transfer function, the transfer function density vector, and the distance from the set of points located on the surface of the virtual three-dimensional shape from the audio output device located inside the virtual three-dimensional shape.
